(19) United States
(12) Patent Application Publication
(10) Pub. No.: US 2022/0161687 A1
(43) Pub. Date: May 26, 2022

(54) ENERGY SYSTEM CONTROL

(71) Applicant: The University of Birmingham, Birmingham, West Midlands (GB)

(72) Inventors: Yousif AL-SAGHEER, Birmingham, West Midlands (GB); Robert STEINBERGER-WILKENS, Birmingham, West Midlands (GB)

(21) Appl. No.: 17/440,995

(22) PCT Filed: Mar. 17, 2020
(86) PCT No.: PCT/GB2020/050674

§ 371 Date: Sep. 20, 2021

(30) Foreign Application Priority Data
Mar. 21, 2019 (GB) 1903895.9

(51) Int. Cl. B60L 58/40; G05B 15/02; H02J 15/00; H02J 3/14; H02J 3/32; H02J 7/00

(52) U.S. Cl. CPC B60L 58/40; G05B 15/02; H02J 15/008; H02J 3/144; H02J 2300/20; H02J 7/00032; H02J 7/0047; H02J 2300/30; H02J 3/32

(57) ABSTRACT

The disclosure concerns a controller arranged to control an energy system where the energy system comprises one or more first energy operators and one or more second energy operators, an energy storing system and an energy storing system monitoring device. The controller is arranged to have control over variation in operation of the one or more first energy operators and variation in operation of the second energy operators is at least partially beyond the control of the controller. At least one of the energy operators is an energy supply system and at least one and the remainder of the energy operators are energy consuming systems. At least two of the energy operators are variable energy operators. Where an energy supply system is a variable energy operator, variation in operation of that energy supply system adjusts the energy it supplies. Where an energy consuming system is a variable energy operator, variation in operation of that energy consuming system adjusts the energy it consumes. Outputs of the energy supply systems, inputs of the energy consuming systems and a connection of the energy storing system are connected by a common connection such that they are maintained at the same potential. The energy storing system is arranged to provide energy to the common connection to compensate where there is a deficit in energy supplied by the at least one energy supply system as compared with the energy demand from the at least one energy consuming system. The controller comprises an input arranged to receive a data signal indicative of the power output of the energy storing system from the energy storing system monitoring device; a processing system arranged to determine, in accordance with the energy storing system power output data received, whether and to what extent there is a deficit which exceeds an energy storing system discharging set point value, and where there is, a variation in control for at least one of the first energy operators corresponding in magnitude to the determined extent of the deficit to compensate and return the deficit to the energy storing system discharging set point value; and an output via which the processing system sends one or more control signals to control the at least one of the first energy operators accordingly.

### TECHNICAL FIELD

The present disclosure concerns energy system control. More specifically the disclosure concerns a controller, an energy system, a method of controlling an energy system, a computer program, a non-transitory computer readable storage medium and a signal.

### BACKGROUND

In circumstances where an energy system comprises multiple energy sources and/or multiple energy sinks where at least one of those is subject to fluctuations in its supply/demand beyond the control of the system, there is a need for compensation where mismatches in supply and demand occur as a result of the fluctuations. Compensation may be provided at least in part by adjusting operation of other sources and/or sinks within the system. Additionally, an energy store may be provided at least in part to compensate whilst any adjustments necessary to the sources and/or sinks are made.

Providing responsive and accurate adjustments is significant because it allows for a reduction in the capacity of the size of the buffer as provided by the energy store and so the size and capacity of the energy store. Existing systems tend to call for ever more accurate prediction models for future energy generation of the system energy source(s) and/or the demand of the system energy sinks. There are however natural limits to how much the accuracy of predictive modelling can be improved.

### SUMMARY OF THE INVENTION

According to a first aspect of the invention there is provided a controller arranged to control an energy system where the energy system comprises one or more first energy operators and one or more second energy operators, an energy storing system and an energy storing system monitoring device,

where the controller is arranged to have control over variation in operation of the one or more first energy operators and variation in operation of the second energy operators is at least partially beyond the control of the controller,

and where at least one of the energy operators is an energy supply system and at least one and the remainder of the energy operators are energy consuming systems,

and where further at least two of the energy operators are variable energy operators, and where an energy supply system is a variable energy operator, variation in operation of that energy supply system adjusts the energy it supplies, and where an energy consuming system is a variable energy operator, variation in operation of that energy consuming system adjusts the energy it consumes,

and where outputs of the energy supply systems, inputs of the energy consuming systems and a connection of the energy storing system are connected by a common connection such that they are maintained at the same potential,

and where further the energy storing system is arranged to provide energy to the common connection to compensate where there is a deficit in energy supplied by the at least one energy supply system as compared with the energy demand from the at least one energy consuming system,

and where the controller comprises:

an input arranged to receive a data signal indicative of the power output of the energy storing system from the energy storing system monitoring device;

a processing system arranged to determine, in accordance with the energy storing system power output data received, whether and to what extent there is a deficit which exceeds an energy storing system discharging set point value, and where there is, a variation in control for at least one of the first energy operators corresponding in magnitude to the determined extent of the deficit to compensate and return the deficit to the energy storing system discharging set point value; and

an output via which the processing system sends one or more control signals to control the at least one of the first energy operators accordingly.

As will be appreciated, the power output of the energy storing system will indicate the extent of the power deficit of the energy supply systems relative to the demand of the energy consuming systems. This allows a suitable adjustment to be made to one or more of the energy operators controllable by the controller to compensate. The controlled system may therefore be considered as self-correcting. Furthermore the adjustment may be based on the real-time power output of the energy storing system. Thus it may be possible to compensate in real-time for moment by moment discrepancies between generation and demand indicated by the power output of the energy storing system. By way of example, where there is a deficit as a consequence of variation in operation of one or more of the second energy operators, an immediate power deficit may be prevented by means of the energy storing system. Meanwhile, controllable system assets can be controlled to bring supply and demand back towards balance. Further, by using the energy storing system power output for control of system compensation (i.e. using the energy storing system as a sensor), simple and accurate control may be achieved. Use of the energy storing system power output may in particular mean that a longer-term prediction algorithm used for modelling supply and/or demand may be allowed to be less sophisticated and less accurate, reducing design time, data, and computational resources required. Specifically, the responsiveness and accuracy of a correction to the prediction as determined in dependence on the energy storing system power output, may reduce the impact of a relatively inaccurate longer-term production. Additionally, or alternatively it may allow for a smaller compensatory power margin to be available where there is a deficit. This may mean that a smaller capacity energy storing system can be employed.

In some embodiments the data received indicative of the power output of the energy storing system are values for the current and voltage of the energy storage system. These values and/or a power output (which may be calculated from them) may be the sole energy system measurements on which basis a determination is made as to the deficit which exceeds the energy storing system discharging set point value, and/or on which basis the variation in control is determined. Indeed, the current and voltage and/or the power output may be the only energy system data used to derive the deficit which exceeds the energy storing system discharging set point value and/or the variation in control. It may be for instance that the current and voltage and/or the power output of the energy storage system is itself taken to be the deficit which exceeds the energy storing system discharging set point value.

In some embodiments the energy storing system discharging set point value is set at a level at which there is substantially zero energy storing system discharging. This may be appropriate where there is no need or desire to discharge the energy storing system other than where necessary to compensate for a deficit. Advantageously, substantially zero energy storing system discharging may allow for relatively low energy storing system charge capacity. This may mean that the energy storing system is smaller and/or less expensive and/or less complicated. Additionally, the life of the energy storing system may be increased due to a reduction in the degree of charging and discharging experienced in an average cycle.

In some embodiments the energy storing system discharging set point value is set at a level at which there is discharging of the energy storing system. This may be appropriate where there is a need or desire to discharge the energy storing system even where there would not otherwise be a deficit. Such an implementation may for example be appropriate in a plug-in hybrid electric vehicle, where it is desired to utilise energy storing system (in this case battery) charge between charging cycles.

In some embodiments the controller is arranged to dynamically vary the energy storing system discharging set point value. This may for instance be performed in dependence on the charge level of the energy storing system. By way of example, the discharging set point value may be set at a level at which there is discharge of the energy storing system only where it is charged above a predefined percentage of full charge. As will be appreciated, the charge level of the energy storing system may be known/estimated based on knowledge of initial energy storing system charge, monitoring conditions thereafter that will result in charging or discharging (e.g. as indicated by the data signal indicative of the power output of the energy storing system) and determining energy storing system charge accordingly. Alternatively, energy storing system charge may be provided to the processing system (e.g. via sensor data provided to the input or an alternative input).

In some embodiments the energy storing system is arranged to be charged using excess energy from the common connection to compensate where there is a surplus in energy supplied by the at least one energy supply system as compared with the energy demand from the at least one energy consuming system. This may prevent unnecessary wastage of supplied energy and may provide a convenient way of maintaining a given potential on the common connection even where there is a surplus in energy supplied by the at least one energy supply system.

In some embodiments the processing system is arranged to determine, in accordance with the energy storing system power output data received, whether and to what extent there is a surplus which exceeds an energy storing system charging set point value, and where there is, a variation in control for at least one of the first energy operators corresponding in magnitude to the determined extent of the deficit to compensate and return the surplus to the energy storing system charging set point value and send one or more control signals to control the at least one of the first energy operators accordingly. The adjustment may be based on the real-time power output of the energy storing system. Thus it may be possible to compensate in real-time for moment by moment discrepancies between generation and demand indicated by the power output of the energy storing system.

In some embodiments the data received indicative of the power output of the energy storing system are values for the current and voltage of the energy storage system. These values and/or the power output (which may be calculated from them) may be the sole energy system measurements on which basis a determination is made as to the surplus which exceeds the energy storing system charging set point value, and/or on which basis the variation in control is determined. Indeed, the current and voltage and/or the power output may be the only energy system data used to derive the surplus which exceeds the energy storing system charging set point value and/or the variation in control. It may be for instance that the current and voltage and/or the power output of the energy storage system is itself taken to be the surplus which exceeds the energy storing system charging set point value.

In some embodiments the energy storing system charging set point value is set at a level at which there is substantially zero energy storing system charging. This may be appropriate where there is no need or desire to charge the energy storing system other than where necessary to compensate for a surplus. Advantageously, substantially zero energy storing system charging may allow for relatively low energy storing system charge capacity. This may mean that the energy storing system is smaller and/or less expensive and/or less complicated. Additionally, the life of the energy storing system may be increased due to a reduction in the degree of charging and discharging experienced in an average cycle.

In some embodiments the energy storing system charging set point value is set at a level at which there is charging of the energy storing system. This may be appropriate where there is a need or desire to charge the energy storing system even where a corresponding surplus must be artificially created in order to do so. Such an implementation may for example be appropriate in a mild or full hybrid vehicle, where it is desired to charge the energy storing system (in this case battery) from another onboard power source.

In some embodiments the controller is arranged to dynamically vary the energy storing system charging set point value. This may be in dependence on the charge level of the energy storing system. By way of example, the charging set point value may be set at a level at which there is charging of the energy storing system only where it is charged below a predefined percentage of full charge.

In some embodiments the controller is arranged to dynamically vary the energy storing system discharging set point value to temporarily over compensate for a deficit to an extent sufficient to return the energy storing system substantially to its state of charge prior to the commencement of the deficit and/or to dynamically vary the energy storing system charging set point value to temporarily over compensate for a surplus to an extent sufficient to return the energy storing system substantially to its state of charge prior to the surplus. In this way any discharging and/or charging of the energy storing system that occurs during a transient discrepancy between the supply and consumption may be reversed and the energy storing system maintained at substantially a consistent level of charge.

In some embodiments the controller is arranged to monitor the energy storing system power output and perform compensatory control of the at least one of the first energy operators dependent on the power output of the energy storing system in real-time. Thus there may be no significant delay between the measuring and receiving of energy storing system power output data and corresponding control of the one or more first energy operators. Furthermore, these steps may be performed repeatedly and at frequency sufficient to give near instantaneous response. This may lead to a size of an energy buffer as provided by the energy storing system (and/or another energy store) needing to be only substantially large enough to compensate for the time it takes for the at least one of the first energy operators to be controlled to compensate for a deficit or surplus.

In some embodiments compensatory control of the at least one of the first energy operators dependent on the power output of the energy storing system is applied as a correction to control dependent on a model of anticipated energy supply and/or energy consumption of the energy supply system. It may be that the model of anticipated energy supply and/or energy consumption of the energy supply system are used in an escalating surplus prediction model used by the controller as a basis to drive the energy system into balance. The escalation process may be stopped by the correction in accordance with the power output of the energy storing system.

In some embodiments the energy system is an electrical energy system.

In some embodiments the energy system is arranged such that a current flowing on the common connection is direct current.

In some embodiments the common connection is a busbar.

In some embodiments the energy storing system comprises a battery.

In some embodiments the first energy operators are selected from among a fuel cell, an electrolyser, an internal combustion engine, a battery and a capacitor. As will be appreciated, multiple examples of any one or more of these may be used where there are multiple energy operators.

In some embodiments the second energy operators are selected from among an intermittent renewable energy source, (e.g. a wind turbine, a photovoltaic cell array, a solar thermal energy array, a tidal energy installation or a wave energy installation) an energy distribution network, a vehicle motor, commercial equipment and a domestic appliance. As will be appreciated, multiple examples of any one or more of these may be used where there are multiple energy operators.

According to a second aspect of the invention there is provided an energy system comprising one or more first energy operators and one or more second energy operators, an energy storing system, an energy storing system monitoring device and a controller,

where the controller is arranged to have control over variation in operation of the one or more first energy operators and variation in operation of the second energy operators is at least partially beyond the control of the controller,

and where at least one of the energy operators is an energy supply system and at least one and the remainder of the energy operators are energy consuming systems,

and where further at least two of the energy operators are variable energy operators, and where an energy supply system is a variable energy operator, variation in operation of that energy supply system adjusts the energy it supplies, and where an energy consuming system is a variable energy operator, variation in operation of that energy consuming system adjusts the energy it consumes,

and where outputs of the energy supply systems, inputs of the energy consuming systems and a connection of the energy storing system are connected by a common connection such that they are maintained at the same potential,

and where further the energy storing system is arranged to provide energy to the common connection to compensate where there is a deficit in energy supplied by the at least one energy supply system as compared with the energy demand from the at least one energy consuming system,

and where the controller comprises:

an input arranged to receive a data signal indicative of the power output of the energy storing system from the energy storing system monitoring device;

a processing system arranged to determine, in accordance with the energy storing system power output data received, whether and to what extent there is a deficit which exceeds an energy storing system discharging set point value, and where there is, a variation in control for at least one of the first energy operators corresponding in magnitude to the determined extent of the deficit to compensate and return the deficit to the energy storing system discharging set point value; and

an output via which the processing system sends one or more control signals to control the at least one of the first energy operators accordingly.

According to a third aspect of the invention there is provided a method of controlling an energy system, where the energy system comprises one or more first energy operators and one or more second energy operators and an energy storing system and where variation in operation of the one or more first energy operators is controllable according to the method while variation in operation of the second energy operators is at least partially beyond the control of the method,

and where at least one of the energy operators is an energy supply system and at least one and the remainder of the energy operators are energy consuming systems,

and where further at least two of the energy operators are variable energy operators, and where an energy supply system is a variable energy operator, variation in operation of that energy supply system adjusts the energy it supplies, and where an energy consuming system is a variable energy operator, variation in operation of that energy consuming system adjusts the energy it consumes,

and where outputs of the energy supply systems, inputs of the energy consuming systems and a connection of the energy storing system are connected by a common connection such that they are maintained at the same potential,

and where further the energy storing system is arranged to provide energy to the common connection to compensate where there is a deficit in energy supplied by the at least one energy supply system as compared with the energy demand from the at least one energy consuming system,

the method comprising:

receiving data indicative of the power output of the energy storing system;

determining, in accordance with the energy storing system power output data received, whether and to what extent there is a deficit which exceeds an energy storing system discharging set point value, and where there is, a variation in control for at least one of the first energy operators corresponding in magnitude to the determined extent of the deficit to compensate and return the deficit to the energy storing system discharging set point value; and

controlling the at least one of the first energy operators accordingly.

According to a fourth aspect of the invention there is provided a computer program that, when read by a computer, causes performance of the method of the third aspect.

According to fifth aspect of the invention there is provided a non-transitory computer readable storage medium comprising computer readable instructions that, when read by a computer, cause performance of the method of the third aspect. The non-transitory computer readable storage medium may be, for example, a USB flash drive, a secure digital (SD) card, an optical disc (such as a compact disc (CD), a digital versatile disc (DVD) or a Blu-ray disc).

According to a sixth aspect of the invention there is provided a signal comprising computer readable instructions that, when read by a computer, cause performance of the method of the third aspect described above.

Any controller or controllers described herein may suitably comprise a control unit or computational device having one or more electronic processors. Thus, the system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. A first controller may be implemented in software run on one or more processors. One or more other controllers may be implemented in software run on one or more processors, optionally the same one or more processors as the first controller. Other suitable arrangements may also be used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described by way of example only, with reference to the accompanying drawings, in which:

FIG. 1 is a schematic representation of a controller according to an embodiment of the invention;

FIG. 2 is a schematic representation of an energy system according to an embodiment of the invention;

FIG. 3 is a schematic representation of an energy system according to an embodiment of the invention;

FIG. 4a is graph showing total energy generated and total energy demanded over a period by the energy system of FIG. 3;

FIG. 4b is a graph showing surplus and deficit of generated energy in accordance with the total energy generated and total energy demanded as shown in FIG. 4a;

FIG. 5 is a graph showing various performance characteristics for the energy system of FIG. 3 operating in accordance with the FIGS. 4a and 4b scenario;

FIG. 6 is a schematic representation of an energy system according to an embodiment of the invention; and

FIG. 7 is a schematic representation of a controller according to an embodiment of the invention.

### DETAILED DESCRIPTION

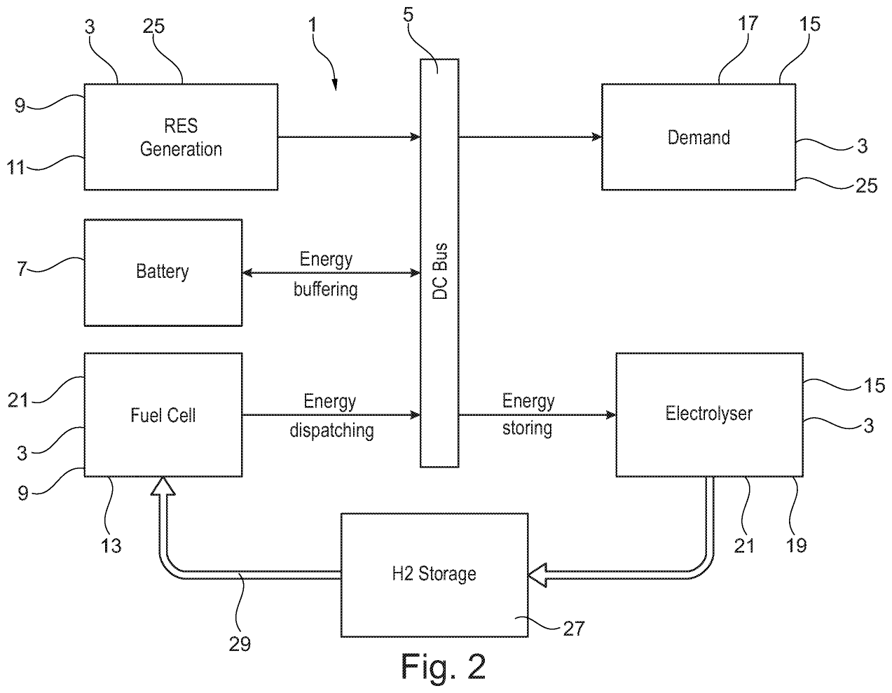

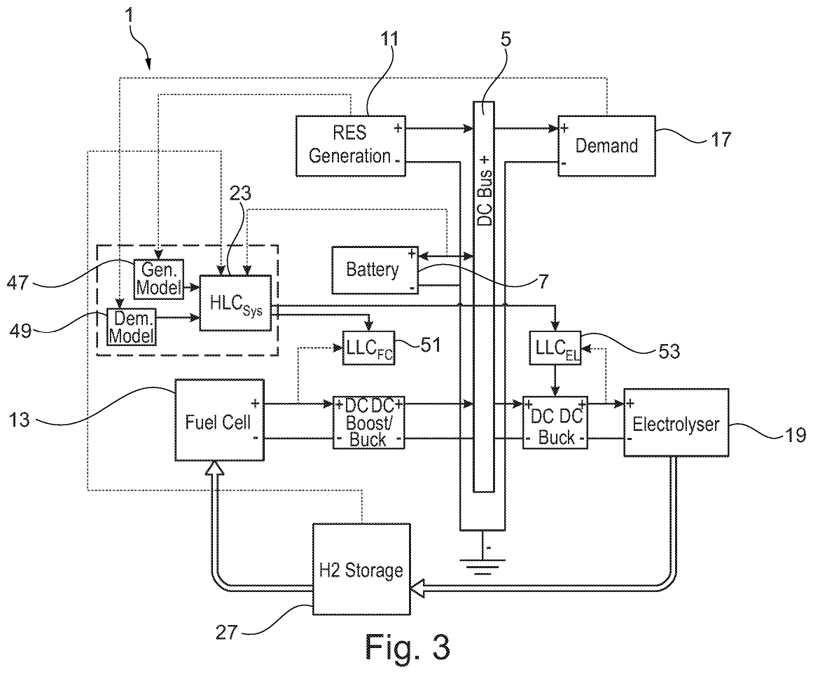

Referring first to FIGS. 2 and 3, an energy system is generally provided at 1. In this case the energy system 1 is an electrical energy system and has a number of energy operators 3, a common connection (in this case a busbar 5) and an energy storing system (in this case a battery 7).

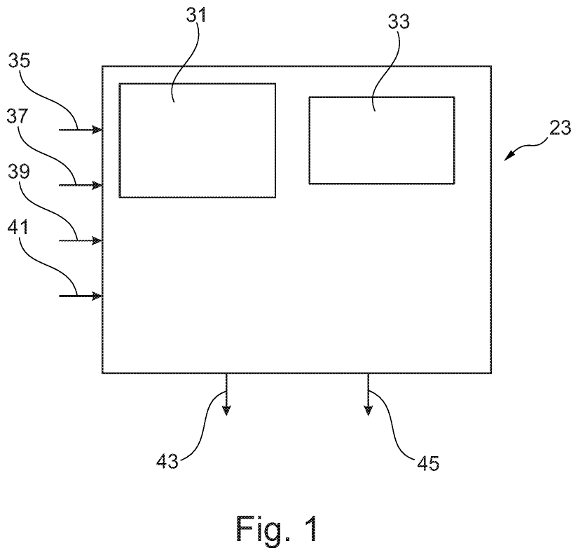

Among the energy operators 3 are those which are energy supply systems 9 (in this case a renewable energy source 11 and a hydrogen fuel cell 13) and those which are energy consuming systems 15 (in this case an electrical demand 17 and an electrolyser 19). In this case, all of the energy operators 3 are variable energy operators, in that the electrical energy which they supply (in the case of energy supply systems 9) and consume (in the case of energy consuming systems 15) in a given time period is variable. Nonetheless, in other embodiments it will be appreciated that one or more of the energy operators 3 may be arranged to supply/demand a fixed quantity of electrical energy in a given time period. Some (first energy operators 21) of the energy operators 3, are controllable by an energy system controller 23 (see FIGS. 1 and 3) to vary, in the case of energy supply systems, their supply and, in the case of energy consuming systems, consumption, of electrical energy in a given time period. The first energy operators 21 are the hydrogen fuel cell 13 and the electrolyser 19. The remainder (second energy operators 25) of the energy operators 3, are not controllable by the energy system controller 23 (nor indeed the energy 1 system itself) to vary their supply/consumption of electrical energy in a given time period. The second energy operators 25 are the renewable energy source 11 and electrical demand 17. In the case of the renewable energy source 11 of the present embodiment, the variation in the energy supplied is driven by weather changes, and in the case of the electrical demand 17, the variation in the consumption is driven by end user usage.

Respective electrical energy outputs of the renewable energy source 11 and hydrogen fuel cell 13 are electrically connected to the busbar 5. Respective electrical energy inputs of the electrical demand 17 and electrolyser 19 are electrically connected to the busbar 5. Finally, an electrical energy connection of the battery 7 is connected to the busbar 5. In use direct current flows through the busbar 5.

A hydrogen gas tank 27 is also provided with hydrogen supply lines 29 from the electrolyser 19 and to the fuel cell 13.

An energy storing system monitoring device (in this case a current sensor (not shown)) is also provided, which detects the current flow from the battery 7.

Referring to FIGS. 1 and 3, the controller 23 has a processor 31, a memory 33, a battery current input 35, a generation modeller input 37, a demand modeller input 39, a tank status input 41, a fuel cell control output 43 and an electrolyser control output 45. The memory 33 is in communication with the processor 31 and stores firmware, software and data for operating the controller 23. The battery current input 35 is arranged to receive data signals from the current sensor indicative of the power output of the battery 7 (in this case the current passing through the battery 7) from the current sensor. The generation modeller input 37 is arranged to receive data signals from an energy generation modeller 47 indicative of predicted energy generation over a given period by the renewable energy source 11. The demand modeller input 39 is arranged to receive data signals from an energy demand modeller 49 indicative of predicted energy demand over the given period by the electrical demand 17. The tank status input 41 is arranged to receive data signals from a pressure sensor (not shown) provided in the hydrogen gas tank 27, indicative of its remaining supply of hydrogen gas. The fuel cell control output 43 is connected to a data input of a fuel cell control module 51 and is arranged to send control signals to vary the control of the fuel cell 13. The electrolyser control output 45 is connected to a data input of an electrolyser control module 53 and is arranged to send control signals to vary the control of the electrolyser 19. The processor 31 is arranged to perform processing operations in accordance with programming.

In use, the energy system 1 generates and supplies electrical energy to the electrical demand 17. Electrical energy to supply the demand 17 is principally generated by the renewable energy source 11, which supplies power to the busbar 5 via its electrical energy output. Electrical energy is delivered from the busbar 5 to the electrical demand 17 via the electrical energy input of electrical demand 17. Nonetheless the electrical energy generated by the renewable energy source 11 is variable in a manner not controllable by the controller 23 nor indeed the wider energy system 1, being subject to the vagaries of the weather. Similarly, so long as it is sufficiently supplied, the consumption of the electrical demand 17 is also variable in a manner not controllable by the controller 23 nor indeed the wider energy system 1, being subject to the vagaries of user demand.

In order that the demands of the electrical demand 17 can be met even where at a particular time there is a deficit in electrical energy generation by the renewable energy source 11 by comparison with that demand, the hydrogen fuel cell 13 is provided to make up the deficit by generating electrical energy using hydrogen stored in the hydrogen gas tank 27. Similarly, in order that any surplus in electrical energy generated by the renewable energy source 11 by comparison with the demand of the electrical demand 17 at a particular time is not wasted, the electrolyser 19 is provided to store the energy chemically by converting it to hydrogen and storing it in the hydrogen gas tank 27.

As will be appreciated, in response to a change in the rate of electrical energy supply from the renewable energy source 11 and/or a change in the rate of electrical energy demand from the electrical demand 17, some time is required to adjust operation of the fuel cell 13 and/or electrolyser 19 to compensate. The battery 7 provides this time, by supplying/absorbing electrical energy to maintain the potential on the busbar 5 while the adjustments are made. The battery 7 however also serves as a sensor, its power consumption, positive or negative, indicating the magnitude of the deficit/surplus, and therefore the adjustment required to the fuel cell and/or the electrolyser to compensate.

The controller 23 controls operation of the energy system 1 as follows. Via its generation modeller input 37, the controller 23 receives updates indicating predicted energy generation over a given time period by the renewable energy source 11 from the energy generation modeller 47. The energy generation modeller 47 itself receives data signals from the renewable energy source 11 indicative of its performance level (e.g. settings and/or maintenance condition) as well as other relevant data for predicting energy generation (in this case weather forecast information and/or measurements of power supplied trend data). The energy generation modeller 47 uses the received data and predicts energy generation for the renewable energy source 11 over the given time period. Via its demand modeller input 39, the controller 23 receives updates indicating predicted energy demand over the given time period of the electrical demand 17 from the energy demand modeller 49. The energy demand modeller 49 itself receives data signals from the electrical demand 17 indicating trend data in terms of its historical demands (e.g. at different times of day, different times of the week and different times of the year) as well as other relevant data for predicting energy demand, e.g. power supplied trend data and/or the likely occurrence of special/unusual events and/or the availability of capacity generated by alternative means. The energy demand modeller 49 uses the received data and predicts energy demand for the electrical demand 17 over the given time period.

Based on the predicted energy generation for the renewable energy source 11, predicted energy demand for the electrical demand 17 and the quantity of hydrogen gas stored in the hydrogen gas tank 27, the processor 31 of the controller calculates a baseline for control of the fuel cell 13 and electrolyser 19 over the given time period such that if the predictions were correct, the energy system 1 would remain substantially stable in that the demands of the electrical demand 17 are met, that over supply by the renewable energy source 11 is stored in the form of hydrogen gas and that hydrogen gas in the hydrogen gas tank 27 is not completely depleted nor that the capacity of the hydrogen gas tank 27 is reached.

In real-time throughout the given time period, the controller 23 adjusts the baseline for control of the fuel cell 13 and electrolyser 19 in accordance with the real time power output of the battery 7 as calculated by the processor 31 in accordance with the received data signals from the current sensor and the real time remaining supply of hydrogen gas in the hydrogen gas tank 27. Because the power output of the battery 7 indicates the moment by moment discrepancy between generated and demanded energy for the energy system 1, it can be used to make adjustments to control of the energy generated by the fuel cell 13 and/or the energy absorbed by the electrolyser 19 to bring the contribution of the battery 7 (in terms of provision or absorption of energy) to a desired level. The processor controls the fuel cell 13 and electrolyser 19 accordingly, sending control signals via the fuel cell control output 43 and electrolyser control output 45 respectively.

As will be appreciated, the baseline for control of the fuel cell 13 and electrolyser 19 may be updated, particularly as new data becomes available. It may be for instance that the baseline is updated continuously e.g. so that it always extends for the pre-determined time period into the future from the current time.

In the present embodiment, it is desired to maintain, to the extent possible, a mid-level charge state on the battery 7. Therefore, the controller 23 controls the fuel cell 13 and electrolyser 19 accordingly, rapidly adjusting their operation to return the battery 7 to a state where there is substantially zero charging/discharging thereof. That is, in this case, the controller 23 operates the fuel cell 13 and electrolyser 19 so that discharge from the battery 7 is maintained at/returned to an energy storing system discharging set point value which is substantially zero. Similarly, the controller 23 operates the fuel cell 13 and electrolyser 19 so that charging of the battery 7 is maintained at/returned to an energy storing system charging set point value which is substantially zero. Nonetheless, the controller 23 does dynamically adjust the energy storing system discharging set point value and the energy storing system charging set point value to maintain the battery 7 charge at a substantially consistent level and/or in order to manage the hydrogen gas reserves in the hydrogen gas tank 27. Thus, for example, the controller 23 temporarily over compensates for a surplus in energy generation to an extent sufficient to return the battery substantially to its state of charge prior to the surplus.

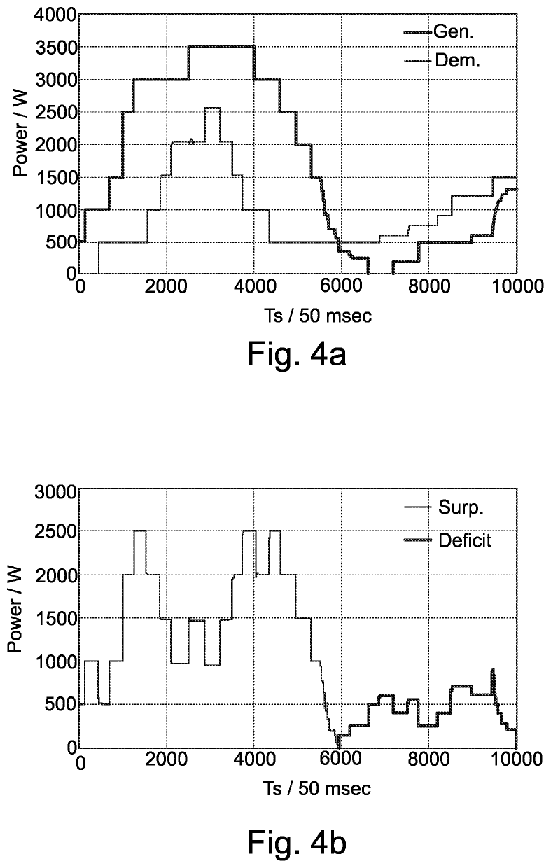

Referring now to FIGS. 4a and 4b, an example indication of the performance of the energy system 1 is shown. In FIG. 4a, the traces indicate that for an initial period the energy generated by the renewable energy source 11) is exceeding the energy demanded by the electrical demand 17), and so during this time, the battery 7 will be charged. At least in part through the action of the controller 23 however, the total energy generated is decreased after its initial peak and the total demand is increased. The controller 23 achieves energy balance by adjusting the operation of the fuel cell 13 and electrolyser 19. Thereafter the traces indicate that the controller 23 begins to reverse the charging of the battery that has occurred by temporarily maintaining the total demand at a level above the total energy generated. FIG. 4b indicates the surplus and deficit in energy generated at different times corresponding to the generation and demand traces shown over the same time period in FIG. 4a.

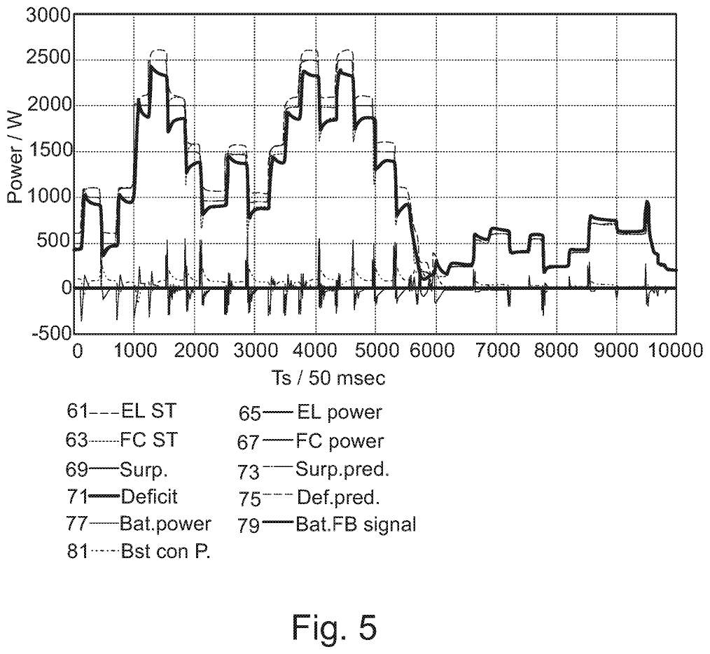

Referring now to FIG. 5, operation traces associated with various performance parameters of the energy system 1 during the example scenario discussed with regard to FIG. 4 are shown. Trace 61 shows a predicted power to be delivered to the electrolyser 19 over time in accordance with the baseline as determined by the processor 31. Trace 63 shows a predicted power to be supplied by the fuel cell 13 over time in accordance with the baseline as determined by the processor 31. Trace 65 shows the actual power delivered to the electrolyser 19 over time as controlled by the controller 23. Trace 67 shows the actual power supplied by the fuel cell 13 over time as controlled by the controller 23. Traces 69 and 71 show respectively the surplus and deficit in energy generated at different times corresponding to the generation and demand traces shown over the same time period in FIG. 4a. Traces 73 and 75 show respectively the predicted surplus and deficit over time in accordance with the baseline as determined by the processor 31. Trace 77 shows the battery 7 power over time as determined by the controller 23 in accordance with the current sensor data signal. Trace 79 shows a feedback signal of the battery 7 power. The feedback signal consists of a cumulative time series of battery power contributions over time as determined by the controller 23. The length of the time series and the weights of its components are determined and adjusted empirically. Trace 81 is the power output of a boost converter of the fuel cell 13. The boost converter regulates the variable voltage of the fuel cell 13 towards the nominal voltage of the busbar 5 and serves as a control element of the fuel cell power.

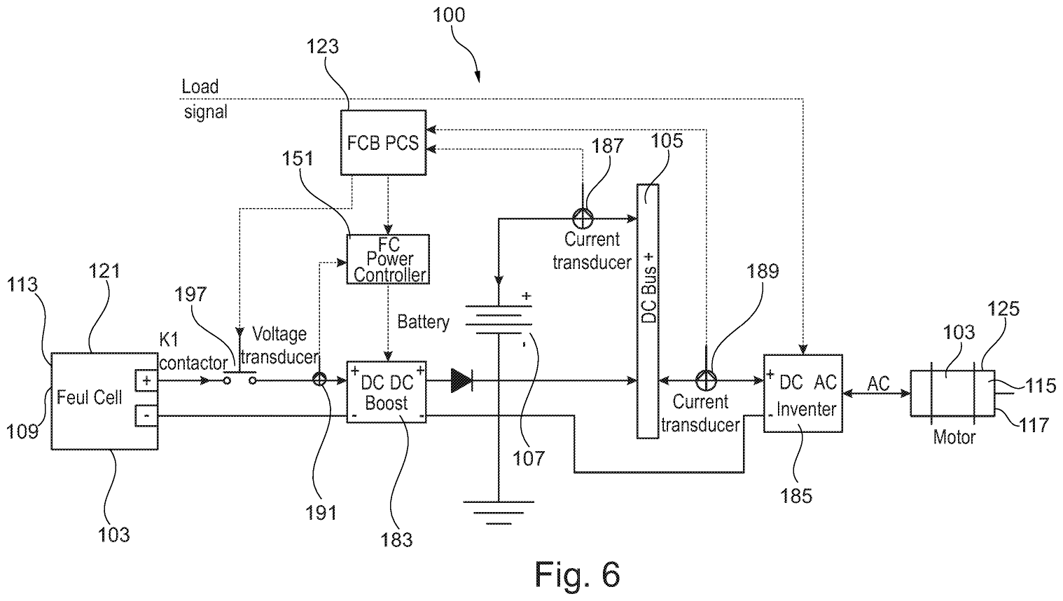

Referring now to FIG. 6 an example of an alternative electric system (in this case for a fuel cell hybrid electric vehicle (FCHEV)) is generally shown at 100. The electric system 100 is similar to the electric system 1 in several ways. The energy system 100 has a number of energy operators 103, a common connection (in this case a busbar 105) and an energy storing system (in this case a battery 107).

Among the energy operators 103 are an energy supply system 109 (in this case a hydrogen fuel cell 113) and an energy consuming system 115 (in this case a motor of the vehicle 117). In this case, all of the energy operators 103 are variable energy operators, in that the electrical energy which they supply (in the case of the energy supply system 109) and consume (in the case of energy consuming system 115) in a given time period is variable. The fuel cell 113 is a first energy operator 121, controllable by an energy system controller 123 to vary its supply of electrical energy in a given time period. The motor of the vehicle 117 is a second energy operator 125, not controllable by the energy system controller 123 (nor indeed the energy 100 system itself) to vary its consumption of electrical energy in a given time period. The variation in the consumption of the motor of the vehicle 117 is driven by demands placed on the vehicle for movement (and may therefore be dependent on factors such as location, road conditions, traffic conditions and/or driving style).

An electrical energy output of the hydrogen fuel cell 113 is electrically connected to the busbar 105 via a boost converter 183. An electrical energy input of the motor of the vehicle 117 is electrically connected to the busbar 105 via a power inverter 185. Finally, an electrical energy connection of the battery 107 is connected to the busbar 105. In use direct current flows through the busbar 105.

An energy storing system monitoring device (in this case a battery current transducer 187) is provided, which detects the current flow from the battery 107. A load current transducer 189 is provided which detects the current flow in the electrical connection between the busbar 105 and the power inverter 185. A voltage transducer 191 is provided which detects the voltage in the electrical connection between the fuel cell 113 and the boost converter 183.

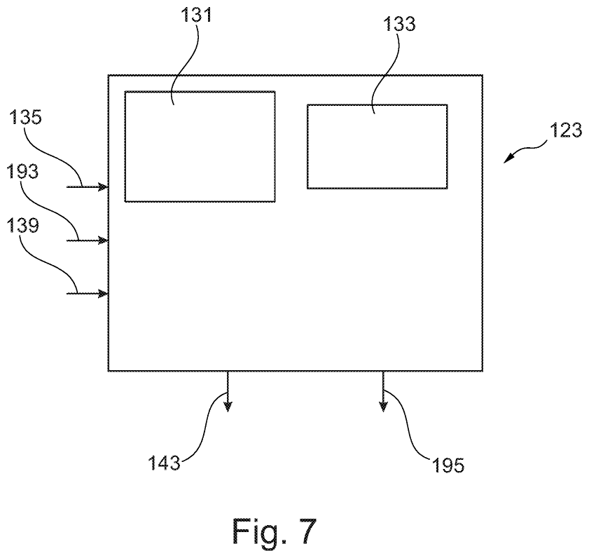

Referring to FIG. 7, the controller 123 has a processor 131, a memory 133, a battery current input 135, a load current input 193, a demand modeller input 139, a fuel cell control output 143 and a switch control output 195. The memory 133 is in communication with the processor 131 and stores firmware, software and data for operating the controller 123. The battery current input 135 is arranged to receive data signals from the battery current transducer 187 indicative of the power output of the battery 107 (in this case the current passing from/to the battery 107) through the battery current transducer 187. The demand modeller input 139 is arranged to receive data signals from an energy demand modeller (not shown) indicative of predicted energy demand over the given period by the motor of the vehicle 117. The demand modeller applies the concept of load following prediction. The fuel cell control output 143 is connected to a data input of a fuel cell control module 151 and is arranged to send control signals to vary the control of the fuel cell 113. The processor 131 is arranged to perform processing operations in accordance with programming.

In use, the energy system 100 generates and supplies electrical energy to the motor of the vehicle 117. Electrical energy to supply the motor of the vehicle 117 is principally generated by the fuel cell 113, which supplies power to the busbar 105 via its electrical energy output and the boost converter 183. Electrical energy is delivered from the busbar 5 to the motor of the vehicle 117 via the power inverter 185 and the electrical energy input of motor of the vehicle 117.

Nonetheless, it may be that at a particular time the electrical energy required/requested by the motor of the vehicle 117 exceeds the electrical energy deliverable by the fuel cell 113 (e.g. because fuel for the fuel cell is depleted or there is a high demand for electrical energy by the motor of the vehicle 117). Additionally and/or alternatively, it may increase the efficiency of the vehicle under at least some operating conditions to supply at least part of the load requirement of the motor of the vehicle 117 from charge stored in the battery 107. In either circumstance, the battery 107 may meet at least part of the load requirement of the motor of the vehicle 117 at a given time. The battery 107 itself may be charged via the busbar 105 at different times where under particular driving operation the motor acts as a brake and/or where the fuel cell generates a surplus of electrical energy by comparison with the demand of the motor of the vehicle 117. Additionally, in this embodiment, the battery is chargeable via a mains connection (e.g. a plug-in connection when the vehicle is not in use). This need not be the case in other embodiments however.

As will be appreciated, in response to a change in the rate of electrical energy demand from the motor of the vehicle 117, it will not be possible to adjust the operation of the fuel cell 113 instantaneously to compensate. The battery 107 therefore also behaves as a buffer, supplying/absorbing electrical energy to maintain the potential on the busbar 105 while any adjustments to the fuel cell 113 operation are made. The battery 107 also serves as a sensor, its power consumption, positive or negative, indicating the magnitude of the deficit/surplus, and therefore informing the adjustment required to the fuel cell to compensate (to the extent that it is not desired that the battery 107 should continue to compensate over a longer period).

The controller 123 controls operation of the energy system 100 as follows. Via its demand modeller input 139, the controller 123 receives updates indicating predicted energy demand in accordance with a load following concept over the given time period of the motor of the vehicle 117 from the energy demand modeller. The energy demand modeller itself receives data signals (i.e. signals from the load current transducer 189) from the motor of the vehicle 117 providing data relevant to present energy demand measurement. The energy demand modeller uses the received data and applies the load following concept to predict energy demand for the motor of the vehicle 117 over the given time period.

Based on predicted (measured in effect) energy demand for the motor of the vehicle 117, the processor 131 of the controller 123 calculates a baseline for control of the fuel cell 113 over the given time period such that if the predictions were correct, the energy system 100 would remain substantially stable in that the demands of the motor of the vehicle 117 are met and that the battery 107 charge is used in accordance with predetermined rules. An example of such a rule might be that the fuel cell 113 is controlled at any given time in such a manner as to promote battery 107 charge use to contribute to the demand of the motor of the vehicle 117 in proportion to the remaining charge of the battery 107. By way of alternative example, the object of the control could be to maintain the battery charge at a consistent charge level (e.g. approximately 50%) whilst providing/absorbing any electrical energy differential between that generated by the fuel cell 113 and the motor of the vehicle 117, to the extent that the battery 107 has capacity so to do. In the present case however, the object of the control is to split power delivered for a given journey between the fuel cell 113 and the battery 107 in accordance with a power split model. The power split is calculated by the controller 123 based on satellite navigation data including traffic updates. The share of the power delivered by the fuel cell 113 and that delivered by the battery 107 is adjusted using the real time power output of the battery 107.

In real-time throughout the given time period, the controller 123 adjusts the baseline for control of the fuel cell 113 in accordance with the real time power output of the battery 107 as calculated by the processor 131 in accordance with the received data signals from the battery current transducer 187. It is noted that using the load current from the load current transducer and the supply voltage from voltage transducer 191 would be insufficient to regulate and maintain the share of power supplied by each of the fuel cell 113 and battery 107, because the system controls only the fuel cell power which is subject to efficiency losses at the boost converter 183. Further these losses are nonlinear at lower power regions of the boost converter 183 operation. Thus the present system controls the battery 107 contribution by controlling the fuel cell 113 contribution based on the real time power output of the battery 107.

Because the power output of the battery 107 indicates the moment by moment discrepancy between generated and demanded energy for the energy system 100, it can be used to make adjustments to control of the energy generated by the fuel cell 113 to bring the contribution of the battery 107 (in terms of provision or absorption of energy) to a desired level. The processor controls the fuel cell 113 accordingly, sending control signals via the fuel cell control output 143. These control signals are received by the fuel cell control module 151, which uses them in combination with data signals it receives from the voltage transducer 191 (indicating the voltage in the electrical connection between the fuel cell 113 and the boost converter 183), to control the boost converter 183. This adjusts the electrical energy provided to the busbar 105 by the fuel cell 113.

Where the controller 123 determines that there should be no contribution from the fuel cell whatsoever, the controller 123 actuates a switch 197, to break the circuit between the fuel cell 113 and the busbar 105, by sending a signal via its switch control output 195. As will be appreciated, the circuit can again be completed as appropriate. Alternatively, zero contribution from the fuel cell can be achieved by requesting zero power output from the fuel cell control module 151 without using the switch 197 to break the circuit between the fuel cell 113 and the busbar 105.

As will be appreciated, the baseline for control of the fuel cell 113 may be updated, particularly as new data becomes available. It may be for instance that the baseline is updated continuously e.g. so that it always extends for the pre-determined time period into the future from the current time.

In the present embodiment, it is desired to gradually deplete the charge level on the battery 107 because it is anticipated that the battery 107 will be periodically re-charged via connection to a charging station. Therefore, the controller 123 controls the fuel cell 113 accordingly, rapidly adjusting its operation to return the battery 107 to a state where there modest discharging is occurring. That is, in this case, the controller 123 operates the fuel cell 113 so that discharge from the battery 107 is maintained at/returned to an energy storing system discharging set point value which is at a predefined non-zero value even where the fuel cell 113 is capable of supplying sufficient electrical energy to match the demand of the motor of the vehicle 117.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A controller arranged to control an energy system where the energy system comprises one or more first energy operators and one or more second energy operators, an energy storing system and an energy storing system monitoring device,
where the controller is arranged to have control over variation in operation of the one or more first energy operators and variation in operation of the second energy operators is at least partially beyond the control of the controller,
and where at least one of the energy operators is an energy supply system and at least one and the remainder of the energy operators are energy consuming systems,
and where further at least two of the energy operators are variable energy operators, and where an energy supply system is a variable energy operator, variation in operation of that energy supply system adjusts the energy it supplies, and where an energy consuming system is a variable energy operator, variation in operation of that energy consuming system adjusts the energy it consumes,
and where outputs of the energy supply systems, inputs of the energy consuming systems and a connection of the energy storing system are connected by a common connection such that they are maintained at the same potential,
and where further the energy storing system is arranged to provide energy to the common connection to compensate where there is a deficit in energy supplied by the at least one energy supply system as compared with the energy demand from the at least one energy consuming system,
and where the controller comprises:
an input arranged to receive a data signal indicative of the power output of the energy storing system from the energy storing system monitoring device;
a processing system arranged to determine, in accordance with the energy storing system power output data received, whether and to what extent there is a deficit which exceeds an energy storing system discharging set point value, and where there is, a variation in control for at least one of the first energy operators corresponding in magnitude to the determined extent of the deficit to compensate and return the deficit to the energy storing system discharging set point value; and
an output via which the processing system sends one or more control signals to control the at least one of the first energy operators accordingly.

2. A controller according to claim 1 where the energy storing system discharging set point value is set at a level at which there is substantially zero energy storing system discharging.

3. A controller according to claim 1 where the energy storing system discharging set point value is set at a level at which there is discharging of the energy storing system.

4. A controller according to claim 1 where the controller is arranged to dynamically vary the energy storing system discharging set point value.

5. A controller according to claim 1 where the controller is arranged to dynamically vary the energy storing system discharging set point value to temporarily over compensate for a deficit to an extent sufficient to return the energy storing system substantially to its state of charge prior to the commencement of the deficit.

6. A controller according to claim 1 where the energy storing system is arranged to be charged using excess energy from the common connection to compensate where there is a surplus in energy supplied by the at least one energy supply system as compared with the energy demand from the at least one energy consuming system.

7. A controller according to claim 6 where the processing system is arranged to determine, in accordance with the energy storing system power output data received, whether and to what extent there is a surplus which exceeds an energy storing system charging set point value, and where there is, a variation in control for at least one of the first energy operators corresponding in magnitude to the determined extent of the deficit to compensate and return the surplus to the energy storing system charging set point value and send one or more control signals to control the at least one of the first energy operators accordingly.

8. A controller according to claim 7 where the energy storing system charging set point value is set at a level at which there is substantially zero energy storing system charging.

9. A controller according to claim 7 where the energy storing system charging set point value is set at a level at which there is charging of the energy storing system.

10. A controller according to claim 7 where the controller is arranged to dynamically vary the energy storing system charging set point value.

11. A controller according to claim 7 where the controller is arranged to dynamically vary the energy storing system charging set point value to temporarily over compensate for a surplus to an extent sufficient to return the energy storing system substantially to its state of charge prior to the surplus.

12. A controller according to claim 1 where the controller is arranged to monitor the energy storing system power output and perform compensatory control of the at least one of the first energy operators dependent on the power output of the energy storing system in real-time.

13. A controller according to claim 1 where compensatory control of the at least one of the first energy operators dependent on the power output of the energy storing system is applied as a correction to control dependent on a model of anticipated energy supply and/or energy consumption of the energy supply system.

14. A controller according to claim 1 where the energy system is an electrical energy system.

15. A controller according to claim 1 where the energy system is arranged such that a current flowing on the common connection is direct current.

16. A controller according to claim 1 where the energy storing system comprises a battery.

17. A controller according to claim 1 where the first energy operators are selected from among a fuel cell, an electrolyser, an internal combustion engine, a battery, a capacitor.

18. A controller according to claim 1 where the second energy operators are selected from among an intermittent renewable energy source, an energy distribution network, a vehicle motor, commercial equipment and a domestic appliance.

19. (canceled)

20. An energy system comprising one or more first energy operators and one or more second energy operators, an energy storing system, an energy storing system monitoring device and a controller,
where the controller is arranged to have control over variation in operation of the one or more first energy operators and variation in operation of the second energy operators is at least partially beyond the control of the controller,
and where at least one of the energy operators is an energy supply system and at least one and the remainder of the energy operators are energy consuming systems,
and where further at least two of the energy operators are variable energy operators, and where an energy supply system is a variable energy operator, variation in operation of that energy supply system adjusts the energy it supplies, and where an energy consuming system is a variable energy operator, variation in operation of that energy consuming system adjusts the energy it consumes,
and where outputs of the energy supply systems, inputs of the energy consuming systems and a connection of the energy storing system are connected by a common connection such that they are maintained at the same potential,
and where further the energy storing system is arranged to provide energy to the common connection to compensate where there is a deficit in energy supplied by the at least one energy supply system as compared with the energy demand from the at least one energy consuming system,
and where the controller comprises:
an input arranged to receive a data signal indicative of the power output of the energy storing system from the energy storing system monitoring device;
a processing system arranged to determine, in accordance with the energy storing system power output data received, whether and to what extent there is a deficit which exceeds an energy storing system discharging set point value, and where there is, a variation in control for at least one of the first energy operators corresponding in magnitude to the determined extent of the deficit to compensate and return the deficit to the energy storing system discharging set point value; and
an output via which the processing system sends one or more control signals to control the at least one of the first energy operators accordingly.

21. A method of controlling an energy system, where the energy system comprises one or more first energy operators and one or more second energy operators and an energy storing system and where variation in operation of the one or more first energy operators is controllable according to the method while variation in operation of the second energy operators is at least partially beyond the control of the method,
and where at least one of the energy operators is an energy supply system and at least one and the remainder of the energy operators are energy consuming systems,
and where further at least two of the energy operators are variable energy operators, and where an energy supply system is a variable energy operator, variation in operation of that energy supply system adjusts the energy it supplies, and where an energy consuming system is a variable energy operator, variation in operation of that energy consuming system adjusts the energy it consumes,
and where outputs of the energy supply systems, inputs of the energy consuming systems and a connection of the energy storing system are connected by a common connection such that they are maintained at the same potential,
and where further the energy storing system is arranged to provide energy to the common connection to compensate where there is a deficit in energy supplied by the at least one energy supply system as compared with the energy demand from the at least one energy consuming system,
the method comprising:
receiving data indicative of the power output of the energy storing system;
determining, in accordance with the energy storing system power output data received, whether and to what extent there is a deficit which exceeds an energy storing system discharging set point value, and where there is, a variation in control for at least one of the first energy operators corresponding in magnitude to the determined extent of the deficit to compensate and return the deficit to the energy storing system discharging set point value; and
controlling the at least one of the first energy operators accordingly.

22.-24. (canceled)
